(19) United States
(12) Patent Application Publication
(10) Pub. No.: US 2026/0185013 A1
(43) Pub. Date: Jul. 2, 2026

(54) SURFACTANT AND CLEANING COMPOSITIONS

(71) Applicant: DELAVAL HOLDING AB, Tumba (SE)

(72) Inventor: Fohona COULIBALY, Tumba (SE)

(21) Appl. No.: 19/131,571

(22) PCT Filed: Nov. 27, 2023
(86) PCT No.: PCT/SE2023/051191

§ 371 Date: May 21, 2025

(30) Foreign Application Priority Data
Dec. 1, 2022 (SE) 2251400-4

(51) Int. Cl. C11D 1/74; C11D 1/88; C11D 3/04; C11D 3/20; C11D 3/33; C11D 3/36

(52) U.S. Cl. CPC C11D 1/74; C11D 1/88; C11D 3/044; C11D 3/2086; C11D 3/33; C11D 3/361; C11D 2111/20

(57) ABSTRACT

Surfactant and cleaning compositions for cleaning of food and beverage processing equipment and milking systems. The surfactant composition includes a hydrocarbon surfactant selected from alkyl glucosides, alkyl poly glucosides and amphoteric-based sultaine surfactants, or combinations thereof, and a fluorosurfactant.

### TECHNICAL FIELD

The invention relates to surfactant and cleaning compositions, for cleaning of food and beverage processing equipment and milking systems.

### BACKGROUND

Adequate cleaning and sanitation is of paramount importance in the food industry to ensure the sustainable production of high quality, safe and nutritious foods. While cleaning and sanitation is primordial in a food production facility, doing it sustainably, at a low cost, with less chemicals and with minimal environmental impact is particularly important.

Traditional cleaning and sanitation routines in a typical food production facility involve the consumption of huge amounts of water. Cleaning processes can account for as much as 60 percent of a food or beverage plant's total water consumption.

Furthermore, for cleaning especially heavy soil, it is common to boost alkaline cleaning solutions with bleach, hydrogen peroxide or other chlorine free bleaching agents like sodium percarbonate and sodium perborate. In addition of increasing the environmental impact, the use of those additive undoubtedly increases the cost to clean.

Moreover acids based cleaners are widely used in the food production industry to clean mineral soils such as calcium carbonate, magnesium phosphate, calcium oxalates etc. Commonly, the use of these acids is preceded by the use of an alkaline cleaner to clean organic soils as well as a potable water rinse.

Technologies are desirable that improve cleaning and sanitation with increase in water savings, energy savings (shorter CIP cleaning times and low wash solution temperature) as well as low environmental impact and a fast turnaround of production equipment being cleaned allow food production facilities to maximize their profits.

### SUMMARY

It is an object of the invention to alleviate some of the shortcomings of prior cleaning compositions and to provide improvements in surfactant and cleaning compositions. According to one aspect of the invention, there is provided a surfactant composition comprising a hydrocarbon surfactant selected from the group consisting of alkyl glycosides, alkyl poly glycosides and amphoteric-based sultaine surfactants, or combinations thereof, and a fluorosurfactant.

The flurosurfactant is used to reduce the surface tension of the surfactant composition including the hydrocarbon surfactant, and ultimately the cleaning concentrate and the diluted cleaning solutions. The surfactant composition provides for synergistic cleaning effects especially in complex soils. Alkyl glycosides tend to help with the cleaning (soil lifting off equipment surface) of fatty soils and burned on soils much more efficiently while amphoteric-based surfactants will help with the cleaning of proteinated soils.

The alkyl glycoside may be an alkyl glucoside, derived from glucose, which has one or more (alkyl poly glucoside) sugar (glucose) molecule in its molecular structure.

The surfactant composition may comprise both an alkyl glycoside (or alkyl poly glycoside), and an amphoteric-based sultaine surfactants, together with a fluorosurfactant. This will enhance the synergistic cleaning effect of the surfactant composition.

Other additional hydrocarbon surfactants that may be included are alkaline stable surfactants such as amine oxide, potassium and sodium salts of alkyl and aryl anionic phosphate esters, fatty alcohol polyethylene-polypropylene glycol end capped as monobenzyl ether and combinations thereof.

The alkyl glycoside may be a C4-C16, preferably a C4-C8, more preferably a C6, alkyl glucoside. This has the benefit of providing a low foam, water soluble and alkaline stable surfactant composition.

The fluorosurfactant may comprise a C3 to C6 fluorosurfactant. The C3 to C6 fluorosurfactant preferably abide by the EPA 2010/15 PFOA Stewardship Programme.

The fluorosurfactant may comprise a C6 water-soluble non-ionic ethoxylated fluorosurfactant.

The fluorosurfactant may comprise an anionic fluorosurfactant.

The fluorosurfactant may comprise an amphoteric fluorosurfactant.

It is noted that preferably, when amphoteric-based sultaine surfactants are used in the composition, the fluorosurfactant is a non-ionic fluorosurfactant as described above.

The surfactant composition may comprise 70-98% w/w, preferably 80-97% w/w, more preferably 90-96% w/w, of the hydrocarbon surfactant, and 2-30% w/w, preferably 3-20% w/w, more preferably 4-10% w/w, of the fluorosurfactant. The total of the hydrocarbon surfactant and the fluorosurfactant is of course 100% w/w or less of the composition.

The surfactant composition may further comprise an ethoxylated alcohol surfactant. The ethoxylated alcohol surfactant is preferably a linear alcohol, C8-C10, ethoxylated propoxylated surfactant, but other ethoxylated propoxylated alcohols, both branched and straight chain, with structure including but not limited to C6-C12 are feasible.

This has the advantage of de-foaming during cleaning, because of foaming due to high soil load. This could be needed e.g. for cleaning of milk soil or liquid egg soil.

The surfactant composition may comprise 2-20% w/w of the ethoxylated alcohol surfactant. The total of the hydrocarbon surfactant, the fluorosurfactant and the ethoxylated alcohol surfactant is 100% w/w or less of the composition.

According to another aspect of the invention there is provided a concentrate cleaning composition comprising an alkaline source, or an acid, and wherein the cleaning composition further comprises the surfactant composition as disclosed herein. The cleaning composition may be chlorine free, which means that no sodium hypochlorite or bleach (NaOCl), hypochlorous acid (HOCl), sodium dichloroisocyanurate (NaDCC) or any other chlorine releasing molecules or compounds are used in the cleaning product formulation or added during cleaning.

The alkaline source is preferably selected from the group consisting of NaOH, KOH and silicates, or combinations thereof.

The acid is preferably a mineral acid or an organic acid. The mineral acid may be selected from the group consisting of phosphoric acid, nitric acid, sulfuric acid, sulfamic acid, hydrochloric acid, hydrofluoric acid. The organic acid may be selected from the group consisting of citric acid, lactic acid, glycolic acid, succinic acid, formic acid, pyruvic acid, malic acid, methane sulfonic acid or combinations thereof.

The cleaning composition may comprise 5-90% w/w, preferably 10-80% w/w, more preferably 20-70% w/w, or around 40% w/w, of the alkaline source or acid. The cleaning composition may further comprise 0.1-5% w/w, preferably 0.2-2% w/w or around 0.5% w/w of the surfactant composition.

The cleaning composition may further comprise from about 1% to about 5% by weight of a chelant. The chelant may be selected from the group consisting of polycarboxylates and their derivatives, and/or gluconates and their derivatives. Suitable polycarboxylate derived chelants are e.g. diethylenetriamine pentaacetate (DTPA), N (Hydroxyethyl)ethylenediaminetriacetic acid (HEDTA), ethylenediaminetetraacetic acid (EDTA), methylglycinediacetic acid (MGDA), L-glutamic acid N,N-diacetic acid (GLDA), Nitrilotriacetic acid (NTA), ethylenediaminedisuccinic acid (EDDS), iminodisuccinic acid (IDS) or citric acid. Suitable gluconate derived chelants are e.g. sodium gluconate, gluconic acid or sodium glucoheptonate.

The cleaning composition may further comprise from about 0.5% to about 4% by weight of a water softener. The water softener may be a phosphonate compound, preferably selected from the group consisting of aminotris(methylphosphonic acid) (ATMP), sodium tripolyphosphate (STTP, 2-phosphonobutane-1,2,4-tricarboxylic acid (PBTC), 1-hydroxyethylidene (1,1-diphosphonicacid) (HEDP), diethylenetriaminepenta(methylene phosphonic acid) (DTPMP), ethylenediaminetetra(methylene phosphonic acid) (EDTMP), or a combination thereof.

According to yet another aspect of the invention there is provided a ready to use cleaning composition comprising the cleaning concentrate composition disclosed herein diluted with water at a volume ratio of between about 1:400 to 1:10, and more preferably between about 1:300 to 1:10. For example a range of use dosage per total volume of solution is about 0.5-10.0 oz/gal. The pH of a diluted alkaline detergent composition may be greater than 10, preferably between about 11 and 14, more preferably between about 12-14. The pH of a diluted acid detergent composition may be less than 6, preferably between about 0 and 5, more preferably between about 1 and 4.

According to yet a further aspect of the invention there is provided a method of cleaning food and beverage processing equipment or a milking system (such as conventional and automatic milking systems) through clean-in-place circulation of a diluted cleaning composition as disclosed herein.

Because the detergent formulation is preferably used for CIP cleaning, it is desirable to have a low foaming. Thus, the preferred detergent formulations comprises of a low foaming surfactant composition that dissipate foam rapidly as described herein. However, in applications where foaming is not a concern or where foaming may be desired, then high foaming surfactants may be used in the detergent formulation to generate foam.

The diluted detergent solution is preferably used at temperature ranging from 70° F.-250° F. (21° C.-121° C.) and most preferably at temperature ranging 100° F.-200° F. (37° C.-93° C.).

The method may provide that the cleaning composition is used in a single step cleaning, without separate alkaline and acid cleaning steps, preferably followed by a water rinse. Water rinse (with potable water) is preferably applied until the rinse water pH is neutral or close/equal to the pH of the potable water used for rinsing. A potable water rinse is recommended after a single step cleaning and before equipment sanitation with an approved sanitizer.

In single step cleaning, the detergent is capable of cleaning both organic soils and mineral scales in a single cleaning step. In single step cleanings, the detergent formulation is suitable to clean organic soils and mineral scales in food and beverage processing facilities where water hardness is particularly high (water hardness>60 mg/L CaCO₃) and without the need for additional acid washing steps.

The detergent formulation may be used for single step cleaning in clean-in-place (CIP) cleaning, clean-out-of-place (COP) cleaning, soak cleaning, spray cleaning or boil out cleaning, among others.

The terms cleaning composition and detergent may be used interchangeably throughout this specification, also the terms blends, compositions or formulations may be used interchangeably.

### FIGURES

FIG. 1 shows a graph of surface tension of surfactant compositions according to the invention.

FIG. 2 shows a critical micelle concentration curve for a surfactant composition used in a cleaning composition according to the invention.

FIG. 3 shows a graph of foam volumes over time of cleaning compositions according to the invention.

FIG. 4 shows a graph of milk soil cleaning efficiency of cleaning compositions according to the invention.

### DETAILED DESCRIPTION

This disclosure relates to fluorosurfactant/hydrocarbon surfactants blends that substantially decreases the surface tension of CIP cleaners for an improved, low cost and sustainable cleaning in the food industry.

The surfactant blends disclosed herein allow us to solve some of the critical problems faced with other CIP cleaners (high dosing, low rinsing, chlorine or peroxide boosting, low cleaning efficacy). This new technology also allows the successful cleaning of various soils in a single CIP step, thus combining the alkaline and acid cleaning steps into one.

According to the present invention fluorosurfactants are blended with hydrocarbon surfactants such as alkyl glucoside, alkyl poly glucoside (APG), amphoteric based sultaine surfactants and mixtures thereof.

Table 1 summarizes exemplary surfactant compositions according to the present invention. The amounts are given by weight/weight percentages (% w/w) of the total composition.

TABLE 1

| w/w % | Broadly preferred | Preferred | Most preferred |
|---|---|---|---|
| Hydrocarbon surfactant | 70-98% | 80-97% | 90-96% |
| Fluorosurfactant | 2-30% | 3-20% | 4-10% |
| Total | 100% | 100% | 100% |

Table 2 shows exemplary surfactant compositions according to the present invention, including an ethoxylated alcohol surfactant. The ethoxylated alcohol surfactant has the additional effect of de-foaming during cleaning, because of foaming due to high soil load. This could be needed e.g. for cleaning of milk soil or other types of soil that has a foaming characteristic.

TABLE 2

| w/w % | Broadly preferred | Preferred | Most preferred |
|---|---|---|---|
| Hydrocarbon surfactant | 55-96% | 65-93% | 80-90% |
| Fluorosurfactant | 2-25% | 3-20% | 4-10% |
| Ethoxylated alcohol | 2-20% | 4-15% | 6-10% |
| surfactant | | | |
| Total | 100% | 100% | 100% |

Table 3 shows examples of surfactant compositions according to the invention. The alkyl glycoside may be a C4-C16, preferably a C4-C8, more preferably a C6, alkyl glucoside. Examples are AG™ 6206 from Nouryon, Jarfactant™ 6206 from Jarchem or Glucopon™ 225DK from BASF. The amphoteric-based sultaine surfactant may be for example Mirataine® ASC from Solvay.

The fluorosurfactant is preferably a C3 to C6 fluorosurfactant that abide by the EPA 2010/15 PFOA Stewardship Programme. According to some examples the fluorosurfactant is a C6 water-soluble non-ionic ethoxylated fluorosurfactant, such as Thetawet™ FS-8050, Thetawet™ FS-8000, Thetawet™ FS-8150 and Flexipel™ S-11WS (all from Innovative Chemical Technologies). According to some examples the fluorosurfactant is an anionic fluorosurfactant, such as Thetawet™ FS-8250, Flexiwet™ NF, Flexiwet™ NF-80, Thetawet™ FS-8020 DB, Thetawet™ FS-8020EB, Thetawet™ FS-8388 (all from Innovative Chemical Technologies). According to some examples the fluorosurfactant is an amphoteric fluorosurfactant such as Thetawet™ FS-8400 (from Innovative Chemical Technologies).

The weight-to-weight ratio of the hydrocarbon surfactant to the fluorosurfactant in the blends B1-B8 in the table 3 is 95:5 (95% w/w hydrocarbon surfactant, 5% w/w fluorosurfactant).

TABLE 3

| Reference | Blend type | Surfactant blends |
|---|---|---|
| B1 | Amphoteric-based sultaine | Mirataine ® ASC + |
| | surfactant + C6 non-ionic | Thetawet ™ FS-8050 |
| | fluorosurfactant | fluorosurfactant |
| B2 | Alkyl poly glucoside surfactant + | Glucopon ™ 225DK + |
| | C6 non-ionic fluorosurfactant | Thetawet ™ FS-8050 |
| | | fluorosurfactant |
| B3 | Alkyl poly glucoside surfactant + | Glucopon ™ 225DK + |
| | C6 anionic fluorosurfactant | Thetawet ™ FS-8250 |
| | | fluorosurfactant |
| B4 | | Nouryon AG ™ 6206 + |
| | | Thetawet ™ FS-8250 |
| | | fluorosurfactant |
| B5 | Alkyl poly glucoside surfactant + | Nouryon AG ™ 6206 + |
| | C6 non-ionic fluorosurfactant | Thetawet ™ FS-8050 |
| | | fluorosurfactant |
| B6 | Amphoteric-based sultaine | Mirataine ® ASC + |
| | surfactant + C6 amphoteric | Thetawet ™ FS-8400 |
| | fluorosurfactant | fluorosurfactant |
| B7 | Alkyl poly glucoside surfactant + | Glucopon ™ 225DK + |
| | C6 amphoteric fluorosurfactant | Thetawet FS-8400 |
| | | fluorosurfactant |
| B8 | | Nouryon AG ™ 6206 + |
| | | Thetawet ™ FS-8400 |
| | | fluorosurfactant |

One preferred composition (B8) comprises 95% w/w of a C6 Alkyl glucoside Alkyl Glucoside from Nouryon (AGR 6206) and 5% w/w of the C6 amphoteric fluorosurfactant Thetawet™ FS-8400. Another preferred composition (B5) comprises 95% w/w of a C6 Alkyl glucoside Alkyl Glucoside from Nouryon (AG™ 6206) and 5% w/w of the C6 amphoteric fluorosurfactant Thetawet™ FS-8050.

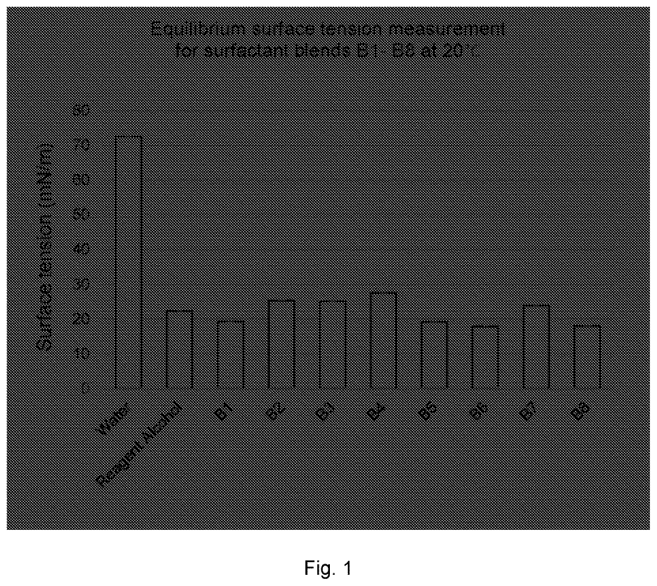

FIG. 1 shows a graph of equilibrium surface tension of the surfactant blends B1-B8, compared to water (high surface tension control) and reagent alcohol (90% ethanol, 5% methanol, 5% isopropyl alcohol, low surface tension control). All equilibrium surface tension measurements were performed by the Wilhelmy plate method on a Kruss Processor Tensiometer K100 at 20° C.+/−0.2° C. Briefly a thin plate attached to a microbalance is slowly brought into contact with the liquid surface and the force resulting from the plate being wet is correlated to the equilibrium surface tension through the Wilhelmy equation: γ=F/l Cos(θ)
where γ is the equiplibrium surface tension, I the wetted perimeter, θ the contact angle between the liquid phase and the plate and F the capillary force exerted on the plate.

As shown in FIG. 1, the equilibrium surface tension of several surfactant blends are measured at 1% w/w and the values are compared to that of water and reagent alcohol. Water and reagent alcohol are used as high surface tension and low surface tension controls, respectively. The results show that for several blends, including B1, B5, B6 and B8, the equilibrium surface tension values are very low and in the sub 20 mN/m region. In fact, for these four blends (B1, B5, B6 and B8) the equilibrium surface tension ranged from 18-19 mN/m. Low equilibrium surface tension blends are preferred in detergent formulations designed for industrial cleaning in the food processing industries or in milking equipment. Among other things, low surface tension detergent formulations facilitate fast cleaning at low chemical dosage, fast rinsing with less water and more efficient cleaning at low temperature (energy saving). In other words, low surface tension cleaning formulations reduce cleaning time while prolonging processing or milking times without compromising cleaning or food quality.

Table 4 shows two examples of alkaline cleaning compositions comprising the surfactant composition (surfactant blend) B8.

TABLE 4
Cleaning composition table

| Ingredient | % w/w Range | Example 1 | Example 2 |
|---|---|---|---|
| Water softener | 0.25-4 | 0.72 | 0.72 |
| Diethylenetriamine | 0.5-10 | 2.6 | 2.6 |
| pentaacetate | | | |
| chelant | | | |
| Sodium Gluconate | 0.5-10 | 3.9 | 3.9 |
| liquid chelant | | | |
| Alkaline source | 2.0-45.0 | 39.65 | 19.83 |
| (NaOH) | | | |
| Alkaline source | 2.0-40.0 | 0 | 19.82 |
| (KOH) | | | |
| Total alkaline source | 2.0-45.0 | 39.65 | 39.65 |
| Surfactant | 0.25-5.0 | 0.38 (Ref B8) | 0.38 (B8) |
| composition | | | |
| Water | Make up | 52.75 | 52.75 |
| Total | 100 | 100 | 100 |

The cleaning composition may be comprised of additional ingredients that will provided specific features and benefits to the cleaning formulation. The list of possible additional ingredients along with their most preferred ranges (% w/w) in the cleaning formulation is presented below.

| | |
|---|---|
| Foaming surfactant | 0.25-10 |
| Cationic surfactant | 0.25-5 |
| Preservative | 0.25-1 |
| Coloring agent | 0.025-0.05 |
| Thickening agent | 0.5-3 |
| Corrosion inhibitor | 0.25-10 |
| Solvent cleaner | 0.25-10 |

The concentrate cleaning composition is diluted with water to form a ready to use cleaning composition to be used for cleaning the food and beverage processing equipment or milking system. The composition is diluted with water at a volume ratio of between 1:400 to 1:10, and more preferably between 1:300 to 1:10. A typical dilution ratio is 1:100.

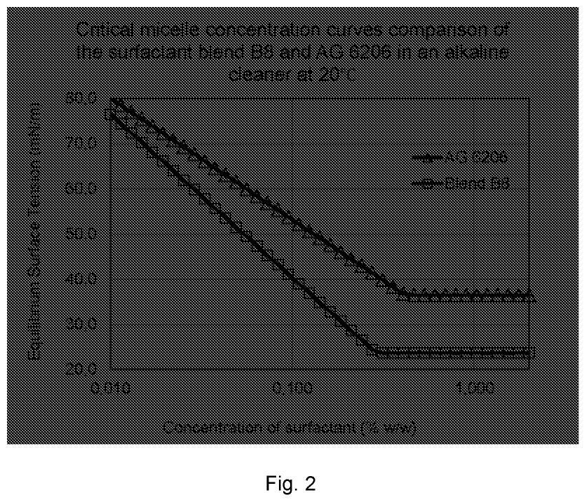

FIG. 2 shows the critical micelle concentration (CMC) of the surfactant blend B8 as compared to AG 6206 in a concentrated detergent cleaner. CMC measurements are performed by increasing the concentration of the surfactant in the base cleaner formulation and recording the equilibrium surface tension value. At the CMC value, the equilibrium surface tension value remains relatively constant or changes with a lower slope. FIG. 2 shows that at all the concentrations of surfactant tested in the CMC curve (0.01-2% w/w), the equilibrium surface tension of the detergent cleaner is reduced dramatically when the surfactant blend (Blend B8) is used versus when AG 6206 is used alone in the detergent cleaner. The CMC value for the surfactant blend (Blend B8) was 0.31% w/w and substantially lower than that of AG 6206 (0.41% w/w). In fact, with AG 6206, at the CMC concentration of 0.31% w/w, the equilibrium surface tension measured in the cleaning product is 36.7 mN/m, while the equilibrium surface tension of the cleaning product when the CMC concentration is reached with the surfactant blend is 23.7 mN/m. This suggests that cleaning products formulated with the surfactant blend (any one of the blends B1-B8) would lead to much lower surface tension cleaning solutions, thus provide much better cleaning results compared to cleaners formulated with AG 6206 alone. All equilibrium surface tension measurements used for the CMC experiment were performed by the Wilhelmy plate method on a Kruss Processor Tensiometer K100 at 20° C.+/−0.2° C. Briefly, a thin plate attached to a microbalance is slowly brought into contact with the liquid surface and the force resulting from the plate being wet is correlated to the equilibrium surface tension through the Wilhelmy equation: γ=F/l Cos(θ)
where γ is the equiplibrium surface tension, l the wetted perimeter, θ the contact angle between the liquid phase and the plate and F the capillary force exerted on the plate.

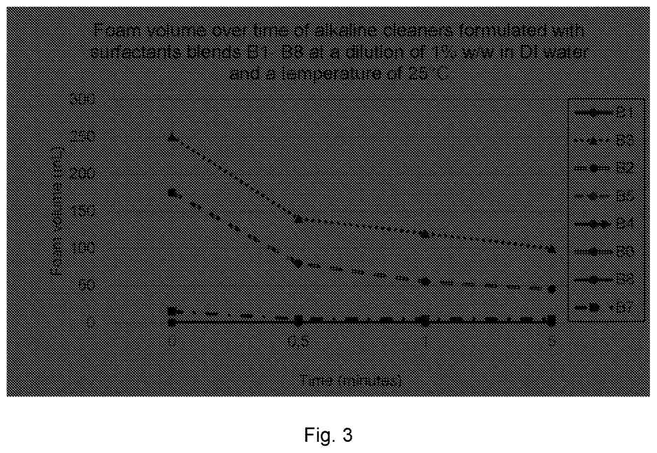

FIG. 3 shows foam volumes measurements over time of diluted detergent solution prepared with different surfactant blends. All detergent solutions are prepared at a dilution of 1% w/w in deionized water. Foam volume was measured using a dynamic foam analyzer at 25° C. Briefly 100 mL of a test solution is pipetted into a 500 mL graduated cylinder and a sparger is immersed into the solution. The initial liquid level is then recorded before an air pump is activated to pump air into the liquid. After 15 seconds the air pump is deactivated and the foam volume is recorded at T0 (0 s), T1 (30 s), T2 (60 s) and T3 (300 s). As shown in FIG. 3, except for products formulated with surfactant blends B2, B3 and to a lesser extent B7, that generated low to high foam volumes, all the cleaning formulations formulated with surfactant blend (B1, B4, B5, B6 and B8) did not generate any measurable foam. That is, the surfactant blends B1, B4, B5, B6 and B8 are more appropriate for CIP products formulation while the surfactant blends B2, B3 and B7 might be more appropriate for foam cleaning product formulation.

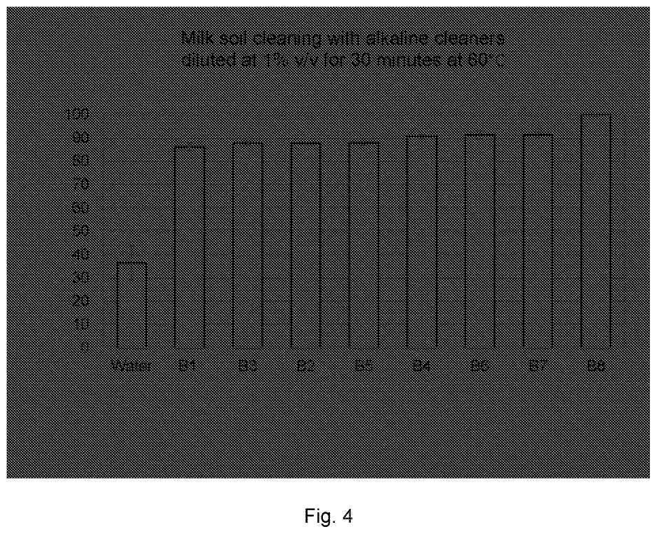

FIG. 4 shows examples of milk soil cleaning using alkaline cleaning compositions with the surfactant blends B1-B8. The cleaning efficiency is measured by immersing 3″×6″ stainless steel 304 panels soiled with milk residues into a 1 L beaker containing 800 mL of a 1% v/v dilution of a cleaning solution in water. The cleaning solution is allowed to stir at 300 rpm for 8 minutes and at 60° C. Prior to soiling the panels, the initial weight of the panels is recorded. After soiling the stainless steel panels, they are allowed to age for at least 8 hours and no more than 24 hours. Then the weight of milk soil deposited onto each stainless steel panel is determined by weighting the soiled panels then subtracting the initial weight of the stainless steel panels. After cleaning in the diluted cleaning solution, the weight of the cleaned panels is also recorded after drying them for at least 1 hours in a temperature-controlled oven. The recorded weight loss is then correlated to the percent cleaning efficiency using the equation below:

$$\% cleaning efficiency = \frac{[ ( Soiled panel weight - Cleaned panel weight )}{( Soiled panel weight - Initial panel weight )} \times 100$$

As shown in FIG. 4, the cleaning solutions formulated with the surfactant blends B1, B2, B3 and B5 provided cleaning results slightly below 90% efficiency. Cleaning solutions formulated with the surfactant blends B4, B6 and B7 provided cleaning efficiencies slightly above 90% while the cleaning solution formulated with the surfactant blend B8 provided a 100% soil cleaning efficiency at 1% v/v. In general, cleaning efficiency results above 80% are deemed acceptable in a controlled laboratory testing. Therefore, the cleaning efficiency results obtained for the cleaning products blended with the surfactant blends (B1-B8) were satisfactory, with the cleaning product blended with the surfactant blend B8 performing the best by removing all of the milk residue soil off the stainless steel panels.

In general, an effective cleaning (including cleaning in place) depends on at least five major parameters including the chemical concentration (dosage of cleaning product), cleaning time, temperature of the cleaning solution, the mechanical action resulting from the circulation as well as the soil load. As an example of a cleaning in place method according to the invention, 1-5 oz/gal dilution of the detergent solution is prepared and heated to a temperature of 100° F.-200° F. (37° C.-93° C.) and circulated in the food and beverage processing equipment or milking system (such as a conventional or automatic milking system) through cleaning in place circulation. The cleaning solution is allowed to circulate for 8 to 15 minutes in a milking system or from 20 to 60 minutes in a CIP system in the food processing industry. The cleaning composition is used in a single step cleaning, without separate alkaline and acid cleaning steps, followed by a water rinse. The water rinse is performed by introducing potable water into the milking or food processing system until the rinse water pH is neutral or close/equal to the pH of the potable water used for rinsing. The water rinse is performed in order to remove any potential residues of the cleaning solution off the food contact surface. After the water rinse, the food processing equipment or milking system is sanitized with an approved sanitizer.

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention, as defined by the claims.

1. A surfactant composition comprising:
a hydrocarbon surfactant selected from the group consisting of alkyl glucosides and alkyl poly glucosides, or combinations thereof, and
a C3-C6 fluorosurfactant, wherein the fluorosurfactant is anionic or amphoteric.

2. The surfactant composition according to claim 1, wherein the alkyl glucoside is a C4-C16 alkyl glucoside.

3. The surfactant composition according to claim 20, wherein the fluorosurfactant comprises a C3-C6 fluorosurfactant.

4. The surfactant composition according to claim 3, wherein the fluorosurfactant comprises a C6 water-soluble non-ionic ethoxylated fluorosurfactant.

5. The surfactant composition according to claim 3, wherein the fluorosurfactant comprises an anionic fluorosurfactant.

6. The surfactant composition according to claim 3, wherein the fluorosurfactant comprises an amphoteric fluorosurfactant.

7. The surfactant composition according to claim 1, wherein the surfactant composition comprises:
70-98% w/w of the hydrocarbon surfactant, and
2-30% w/w of the fluorosurfactant.

8. The surfactant composition according to claim 1, further comprising an ethoxylated alcohol surfactant.

9. The surfactant composition according to claim 8, wherein the surfactant composition comprises 2-20% w/w of the ethoxylated alcohol surfactant.

10. A concentrate cleaning composition comprising:
an alkaline source, or an acid, and
the surfactant composition according to claim 1.

11. The concentrate cleaning composition according to claim 10, wherein the concentrate cleaning composition comprises:
5-90% w/w of the alkaline source or acid, and
0.1-5% w/w of the surfactant composition.

12. The concentrate cleaning composition according to claim 10, further comprising from about 1% to about 5% by weight of a chelant.

13. The concentrate cleaning composition according to claim 12, wherein the chelant is selected from the group consisting of polycarboxylate and their derivatives, gluconates and their derivatives, or a combination thereof.

14. The concentrate cleaning composition according to claim 10, further comprising from about 0.5% to about 4% by weight of a water softener.

15. The concentrate cleaning composition according to claim 14, wherein the water softener is a phosphonate compound.

16. A ready to use cleaning composition comprising:
the concentrate cleaning composition according to claim 10 diluted with water at a volume ratio of between 1:400 to 1:10.

17. A method of cleaning food and beverage processing equipment, or a milking system, comprising through clean-in-place circulating the ready to use cleaning composition according to claim 16.

18. The method according to claim 17, where the ready to use cleaning composition is used in a single step cleaning, without separate alkaline and acid cleaning steps, and followed by a water rinse and sanitation.

19. A surfactant composition comprising:
a hydrocarbon surfactant selected from the group consisting of alkyl glucosides, alkyl poly glucosides, and amphoteric-based sultaine surfactants, or combinations thereof, and
a C3-C6 amphoteric fluorosurfactant.

20. A surfactant composition comprising:
70-98% w/w of a hydrocarbon surfactant selected from the group consisting of alkyl glucosides and alkyl poly glucosides, or combinations thereof, and
2-30% w/w of a fluorosurfactant.
